(19) United States
(12) Patent Application Publication
(10) Pub. No.: US 2021/0270186 A1
(43) Pub. Date: Sep. 2, 2021

(54) FUEL INJECTION DEVICE FOR GAS TURBINE

(71) Applicant: HONDA MOTOR CO., LTD., Tokyo (JP)

(72) Inventor: Orio NAKAMURA, Saitama (JP)

(21) Appl. No.: 17/166,621

(22) Filed: Feb. 3, 2021

(30) Foreign Application Priority Data
Feb. 28, 2020 (JP) 2020-034041

(51) Int. Cl. F02C 7/232; F23R 3/28

(52) U.S. Cl. CPC F02C 7/232; F05D 2240/36; F05D 2220/32; F23R 3/28

(57) ABSTRACT

In a fuel injection device for a gas turbine including a cylindrical nozzle body extending in a predetermined axial direction, and a stem portion supporting the nozzle body on a casing of the gas turbine, the stem portion includes a first inclined section extending from a peripheral part of the nozzle body in a radial direction with respect to a central axial line of the nozzle body in a circumferentially offset relationship to a line extending between a central axial line of the gas turbine and the central axial line of the nozzle body with respect to the central axial line of the gas turbine, and a second inclined section extending from a free end of the first inclined section to the casing.

### TECHNICAL FIELD

The present invention relates to a fuel injection device for a gas turbine.

### BACKGROUND ART

A known fuel injection device for a gas turbine includes a nozzle body provided with a nozzle for injecting fuel into the combustion chamber of the gas turbine, and a stem portion connected to a side part of the nozzle body to support the nozzle body relative to the engine casing and internally defining a fuel passage to supply fuel to the nozzle body. See JP2016-41999A, for instance.

In the known fuel injection device for a gas turbine, the nozzle body and the stem portion are arranged such that the axial lines of the nozzle body and the stem portion cross each other. Since the axial lines of the nozzle body and the stem portion are located on a same circumferential position in a plane orthogonal to the central axial line of the gas turbine, or located on a same radial line emanating from the central axial line of the gas turbine (as shown by the imaginary lines in FIG. 5), the peripheral parts of the nozzle body and the stem portion tend to interfere with each other in the radial direction of the gas turbine.

Therefore, in order to minimize the outer diameter of the gas turbine, the diameters of the nozzle body and the stem portion are required to be reduced, and this creates various issues in engine design.

For instance, the nozzle body is desired to be fitted with a swirler having a relatively large diameter for improved engine performance, and this inevitably causes the outer diameter of the nozzle body to be significant. Furthermore, the stem portion is required to be placed between a side part of the nozzle body and the surrounding casing of the engine. As a result, the outer diameter of the engine or the casing becomes undesirably great.

### SUMMARY OF THE INVENTION

In view of such a problem of the prior art, a primary object of the present invention is to provide a fuel injection device for a gas turbine that may be fitted with a nozzle body having a relatively large diameter without causing the overall size of the engine to be increased.

To achieve such an object, the present invention provides a fuel injection device (70) for a gas turbine, configured to inject fuel into a combustion chamber (52) defined by a combustor (54), comprising: a cylindrical nozzle body (72) extending in a predetermined axial direction and having a first end (72A) facing the combustion chamber, the nozzle body being provided with a nozzle fuel passage (86, 88) extending in the axial direction, and a fuel injection port (90) formed in an end of the nozzle fuel passage (112) on a side of the first end; and a stem portion (110) connected to a side part of the nozzle body, and supporting the nozzle body on a casing (14) of the gas turbine surrounding the combustor, the stem portion being provided with a stem fuel passage communicating with the nozzle fuel passage, wherein the stem portion includes a first inclined section (110A) extending from a peripheral part of the nozzle body in a radial direction with respect to a central axial line (B) of the nozzle body in a circumferentially offset relationship to a line extending between a central axial line (A) of the gas turbine and the central axial line of the nozzle body with respect to the central axial line of the gas turbine, and a second inclined section (110C) extending from a free end of the first inclined section to the casing

Thereby, the diameter of the nozzle body can be increased without increasing the overall size of the gas turbine.

Preferably, the stem portion further includes an axial section (110B) extending in parallel with the central axial line of the nozzle body between a radially outer end of the first inclined section and a radially inner end of the second inclined section.

Thereby, the stem portion can be better adapted to the inclination of the wall part of the casing through which the stem portion is passed.

Preferably, the central axial line of the second inclined section of the stem portion and the central axial line of the nozzle body are in a skewed relationship to each other.

Thereby, the first inclined section and the axial section of the stem portion is prevented from interfering with the nozzle body so that the fuel injection device may be fitted with a nozzle body having a relatively large diameter without causing the overall size of the gas turbine to be increased.

The present invention thus provides a fuel injection device for a gas turbine that may be fitted with a nozzle body have a relatively large diameter without causing the overall size of the gas turbine to be increased.

### BRIEF DESCRIPTION OF THE DRAWING(S)

FIG. 1 is a longitudinal sectional view of an aircraft gas turbine engine fitted with fuel injection devices according to an embodiment of the present invention;

FIG. 2 is a longitudinal sectional view of the fuel injection device including a nozzle body and a stem portion;

FIG. 3 is a view similar to FIG. 4 showing the stem portion of the fuel injection device also in section;

FIG. 4 is a rear view of the fuel injection device; and

FIG. 5 is a diagram illustrating the positional relationship between the nozzle body and the stem portion of the gas turbine as view from an axial direction of the gas turbine.

### DESCRIPTION OF THE PREFERRED EMBODIMENT(S)

A fuel injection device according to an embodiment of the present invention as applied to an aircraft gas turbine engine is described in the following with reference to the appended drawings.

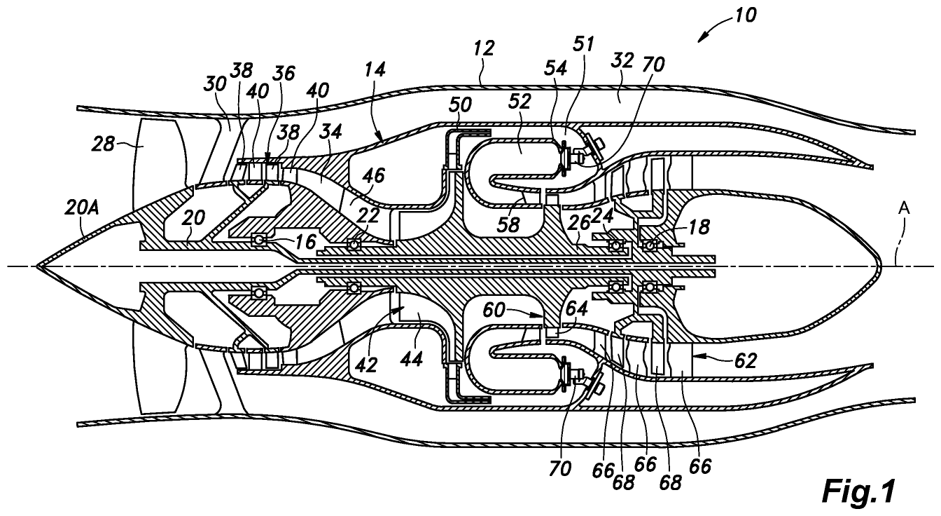

First of all, an overall structure of the aircraft gas turbine engine (turbofan engine) is briefly described in the following with reference to FIG. 1.

The gas turbine 10 has a substantially cylindrical outer casing 12 and an inner casing 14 arranged in a coaxial relationship. The inner casing 14 rotatably supports a low-pressure rotary shaft 20 via a front first bearing 16 and a rear first bearing 18. The low-pressure rotary shaft 20 is surrounded by a hollow high-pressure rotary shaft 26 in a coaxial relationship, and the high-pressure rotary shaft 26 is rotatably supported by the inner casing 14 via a front second bearing 22 and a rear second bearing 24.

Thus, the low-pressure rotary shaft 20 and the high-pressure rotary shaft 26 are arranged coaxially to a central axial line A of the gas turbine 10.

The front end of the low-pressure rotary shaft 20 is flitted with a substantially conical tip portion 20A protruding forward from the inner casing 14. A plurality of front fan blades 28 are provided in a single row on the outer periphery of the tip portion 20A, and a plurality of stator vanes 30 extend radially inward from the outer casing 12 in a single row to be positioned immediately downstream of the front fan blades 28. On the downstream side of the stator vanes 30 are located a bypass duct 32 having an annular cross section defined between the outer casing 12 and the inner casing 14 and an air compression duct 34 (annular fluid passage) having an annular cross section defined within the inner casing 14 in a mutually coaxial and parallel relationship.

An axial flow compressor 36 is provided at the inlet of the air compression duct 34. The axial flow compressor 36 includes a pair of rows of rotor blades 38 extending radially outward from the outer periphery of the low-pressure rotary shaft 20, and a pair of rows of stationary vanes 40 provided on the inner casing 14 so as to alternate with the rows of rotor blades 38 along the axial direction.

A centrifugal compressor 42 is provided at the outlet of the air compression duct 34. The centrifugal compressor 42 includes an impeller 44 fixedly fitted on the high-pressure rotary shaft 26. A strut 46 is positioned immediately upstream of the impeller 44. A diffuser 50 is fixed to the inner casing 14 at the outlet end of the centrifugal compressor 42.

A combustor 54 with an annular configuration is provided downstream of the diffuser 50. The combustor 54 internally defines an annular backflow combustion chamber 52 centered around the central axial line A. The compressed air exiting from the diffuser 50 is supplied to the backflow combustion chamber 52 via a compressed air passage 51.

A plurality of fuel injection devices 70 for injecting fuel into the backflow combustion chamber 52 are provided in the rear end parts of the combustor 54 at regular intervals along the circumferential direction. Each fuel injection device 70 includes a nozzle body 72 extending in parallel with the central axial line A of the gas turbine 10 and connected to the combustor 54 at the front end thereof, and a stem portion 110 extending from a side part of the nozzle body 72 through the inner casing 14, and fixedly attached to the inner casing 14 as will be described hereinafter. Each fuel injection device 70 is configured to inject fuel into the backflow combustion chamber 52. The injected fuel is mixed with the compressed air introduced from the compressed air passage 51, and the mixture is combusted in the backflow combustion chamber 52. As a result, high-temperature combustion gas is generated in the backflow combustion chamber 52.

The combustion gas generated in the backflow combustion chamber 52 is forwarded to a high-pressure turbine 60 and a low-pressure turbine 62 provided on the downstream of the backflow combustion chamber 52. The high-pressure turbine 60 includes a row of stationary vanes 58 fixed to the outlet end of the backflow combustion chamber 52, and a row of moveable blades 64 fixed to the outer periphery of the high-pressure rotary shaft 26. The low-pressure turbine 62 is located on the downstream side of the high-pressure turbine 60, and includes a plurality of rows of stationary vanes 66 fixed to the inner casing 14 and a plurality of rows of moveable blades 68 fixed the outer periphery of the low-pressure rotary shaft 20 so as to alternate with the rows of stationary vane 66 along the axial direction.

When starting the gas turbine 10, the high-pressure rotary shaft 26 is rotationally driven by a starter motor (not shown in the drawings). When the high-pressure rotary shaft 26 is rotationally driven, the air compressed by the centrifugal compressor 42 is supplied to the backflow combustion chamber 52, and combustion gas is generated in the backflow combustion chamber 52 by the combustion of the air-fuel mixture. The combustion gas is impinged upon the moveable blades 64 and 68 to rotate the high-pressure rotary shaft 26 and the low-pressure rotary shaft 20, respectively.

As a result, the low-pressure rotary shaft 20 and the high-pressure rotary shaft 26 are rotationally driven so that the front fan blades 28 are rotated, and the axial flow compressor 36 and the centrifugal compressor 42 are operated. The resulting compressed air is supplied to the backflow combustion chamber 52 causing the gas turbine 10 to be continuously operated without the aid of the starter motor.

During the operation of the gas turbine 10, a part of the air drawn by the front fan blades 28 passes through the bypass duct 32 defined between the outer casing 12 and the inner casing 14, and is ejected from the rear end of the gas turbine 10 to generate thrust. The rest of the air drawn by the front fan blades 28 is supplied to the backflow combustion chamber 52 to be mixed with fuel, and the combustion gas generated in the backflow combustion chamber 52 contributes to the rotational drive of the low-pressure rotary shaft 20 and the high-pressure rotary shaft 26, and then ejected rearward to generate additional thrust.

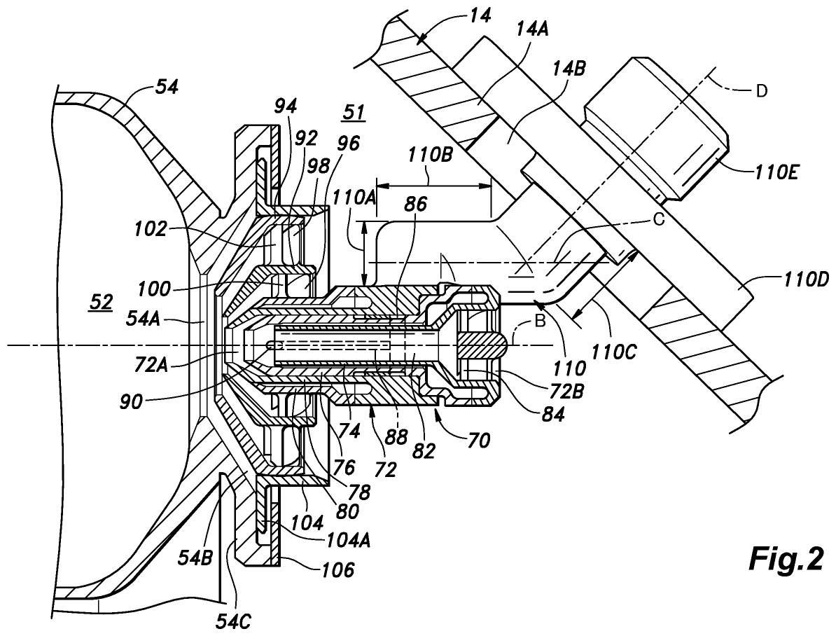

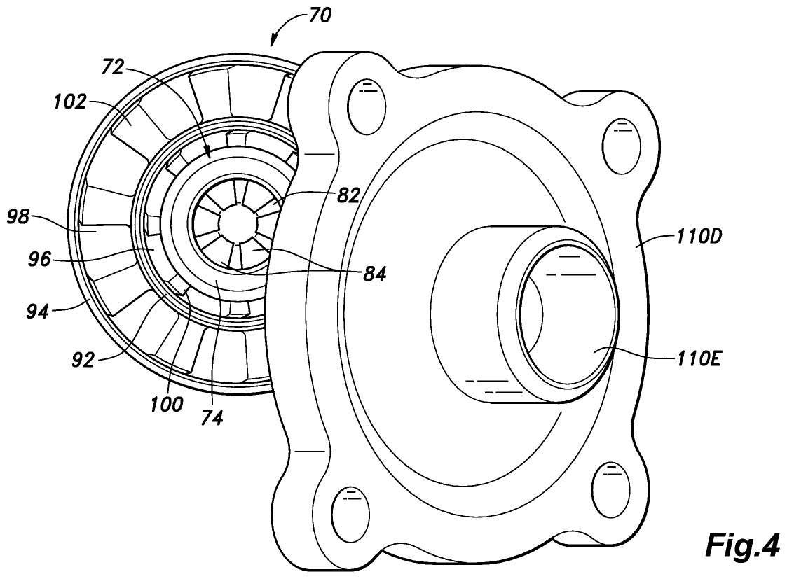

The details of the fuel injection device 70 are described in the following with reference to FIGS. 2 to 5. The fuel injection device 70 includes the cylindrical nozzle body 72 and the stem portion 110 as discussed earlier.

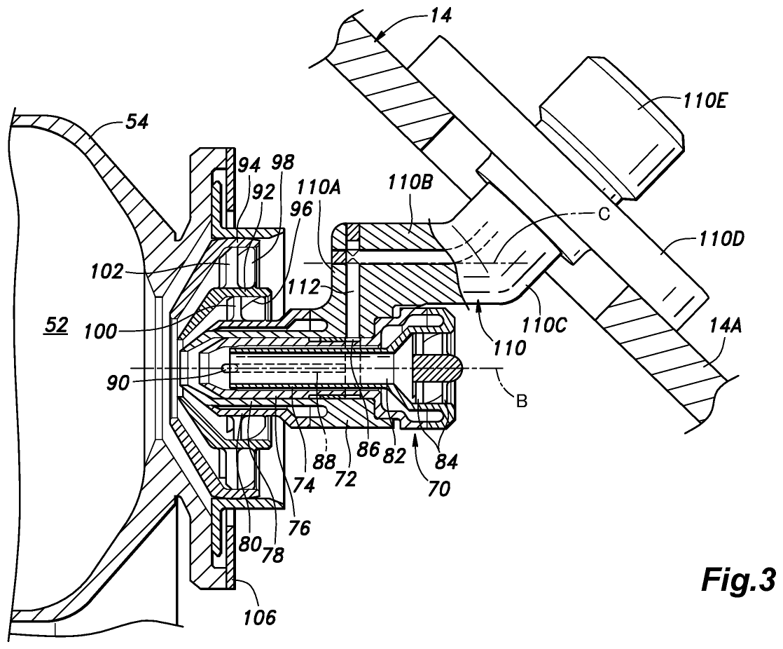

As shown in FIGS. 2 and 3, the nozzle body 72 extends in parallel with the central axial line A of the gas turbine 10, and includes a cylindrical central cylinder 74, a first intermediate cylinder 76, a second intermediate cylinder 78, and an outer cylinder 80, all arranged in a coaxial relationship to a central axial line B of the nozzle body 72 which is in parallel with the central axial line A of the gas turbine 10. The nozzle body 72 has a first end 72A facing the backflow combustion chamber 52, and a second end 72B facing away from the first end 72A with respect to the axial direction.

The central cylinder 74 internally defines a central air passage 82, and the compressed air from the centrifugal compressor 42 is drawn from an opening in the rear end thereof (on the side of the second end 73B), and is ejected from an opening in the front end (on the side of the first end 73A) into the backflow combustion chamber 52.

The central cylinder 74 is enlarged in diameter in the rear end part thereof, and swirl flow generating vanes 84 are provided in the enlarged rear end part of the central cylinder 74 for generating a swirl flow centered around the central axial line B. As a result, the high-pressure air ejected from the central air passage 82 into the backflow combustion chamber 52 contains a swirl flow centered around the central axial line B.

The first intermediate cylinder 76 is closely fitted into the second intermediate cylinder 78. A circumferential groove is formed on the outer circumferential surface of the first intermediate cylinder 76 so as to form an annular fuel passage 86 between the first intermediate cylinder 76 and the second intermediate cylinder 78. A plurality of axial grooves are formed on the outer circumferential surface of the first intermediate cylinder 76 at regular circumferential intervals so as to form a plurality of axial fuel passages 88 between the first intermediate cylinder 76 and the second intermediate cylinder 78. The rear end of each axial fuel passage 88 communicates with the annular fuel passage 86. The front end of each axial fuel passage 88 extends slightly beyond the front end of the central cylinder 74, and is provided with a fuel injection port 90 that is passed through the wall of the first intermediate cylinder 76.

An enlarged inner cylinder 92 and an enlarged outer cylinder 94 having a larger inner diameter than the outer diameter of the enlarged inner cylinder 92 are fitted on the front end (on the side of the first end 72A) of the outer cylinder 80 in a coaxial relationship to the central axial line B of the fuel injection device 70. An annular outer air passage 96 is defined between the outer cylinder 80 and the enlarged inner cylinder 92, and another annular external air passage 98 is defined between the enlarged inner cylinder 92 and the enlarged outer cylinder 94. The outer air passages 96 and 98 are provided with swirl flow generating vanes 100 and 102 that create swirl flows around the central axial line B.

The front ends of the enlarged inner cylinder 92 and the enlarged outer cylinder 94 are tapered toward the front ends thereof so that the annular outer passages 96 and 98 are provided with diameters that progressively decrease toward the front ends thereof. Similarly, the diameters of the first intermediate cylinder 76, the second intermediate cylinder 78, and the outer cylinder 80 are tapered toward the front ends thereof. The front ends of the central cylinder 74, the first intermediate cylinder 76, the second intermediate cylinder 78, second intermediate cylinder 78, the enlarged inner cylinder 92, and the enlarged outer cylinder 94 all face the interior of the backflow combustion chamber 52. The stem portion 110 is internally provided with a stem fuel passage 112 which communicates with the annular fuel passage 86.

The combustor 54 is provided with a plurality of circular openings 54A arranged circumferentially at regular intervals around the central axial line A of the gas turbine 10, and each circular opening 54A is centered on the central axial line B. The open end 54B or the rear end of the circular opening 54A is flared so as to conform to the tapered profile of the enlarged outer cylinder 94. The circular opening 54A is surrounded by a radial flange 54C which is integral with the wall of the combustor 54. The nozzle body 72 is attached to the combustor 54 via a flanged collar 104. The collar 104 is attached to the outer surface of the enlarged outer cylinder 94 in a coaxial relationship. A flange 104A of the collar 104 is interposed between the rear end surface of the radial flange 54C and a mounting plate 106 having a coaxial annular shape and fixedly attached to the rear face of an outer peripheral part of the radial flange 54C so as to create a certain play in both the radial direction and the axial direction so that the nozzle body 72 is slightly moveable relative to the combustor 54 both in the radial direction and the axial direction.

Thus, the fuel introduced from the stem fuel passage 112 is conducted to the annular fuel passage 86, and thence to the axial fuel passages 88. The compressed air in the compressed air passage 51 is introduced into the central air passage 82 from the rear end thereof, and is injected into the backflow combustion chamber 52 from the front end of the central air passage 82. This air flow includes a swirl air flow created by the swirl flow generating vanes 84. As this air flow passes the fuel injection ports 90, the fuel in the axial fuel passages 88 is expelled from the fuel injection ports 90 in the form of fuel mist, and flows into the backflow combustion chamber 52.

The compressed air in the compressed air passage 51 flows into the backflow combustion chamber 52 also through the outer air passages 96 and 98, and this air flow assists the vaporization of the fuel. Owing to the presence of the swirl flow generating vanes 100 and 102, the vaporization of the injected fuel is further promoted.

The stem portion 110 includes a first inclined section 110A extending from a peripheral part of the nozzle body 72 radially outward with respect to the central axial line B of the nozzle body 72 and at an angle to or in a circumferentially offset relationship to a line extending between a central axial line A of the gas turbine 10 and the central axial line B of the nozzle body 72 with respect to the central axial line of the gas turbine 10. As a result, the central axial line D of the second inclined section 110C of the stem portion 110 and the central axial line B of the nozzle body 72 are in a skewed relationship with each other.

The stem portion 110 further includes an axial section 110B extending from the free end (radially outer end) of the first inclined section 110A in parallel with the central axial line B of the nozzle body 72, and a second inclined section 110C extending from the other end of the axial section 110B at an angle to the axial direction of the nozzle body 72. Preferably, the second inclined section 110C is passed through the casing 14. The axial section 110B closely adjoins the outer surface of the nozzle body 72. In particular, the second inclined section 110C extends from the axial section 110B to move radially outward from the central axial line A of the gas turbine 10 toward the rear end thereof. The first inclined section 110A, the axial section 110B, and the second inclined section 110C each consist of a substantially linear section. Depending on the configuration of the casing 14, the axial length of the axial section 110B may be reduced to a value close to or equal to zero so that the first inclined section 110A and the second inclined section 110C may be substantially directly connected to each other.

The rear end of the second inclined section 110C is passed through an inclined wall part 14A of the inner casing 14 in a substantially orthogonal relationship to the inclined wall part 14A. The rear end of the second inclined section 110C is fixedly provided with a radial flange 110D which abuts against the outer surface of the inclined wall part 14A of the inner casing 14, and is fastened to the outer surface of the inclined wall part 14A by threaded bolts not shown in the drawings. Thus, the stem portion 110 is fixedly attached to the inner casing 14, and supports the nozzle body 72 with respect to the part of the inner casing 14 surrounding the combustors 54.

The stem fuel passage 112 extends through the stem portion 110 so that the fuel supplied from a fuel pipe (not shown in the drawings) to the inlet end of the stem fuel passage 112 at the outer end of the second inclined section 110C is delivered to the annular fuel passage 86 via the stem fuel passage 112.

The inclination angle of the second inclined section 110C is selected so that the second inclined section 110C extends through the inclined wall part 14A of the inner casing 14 orthogonally.

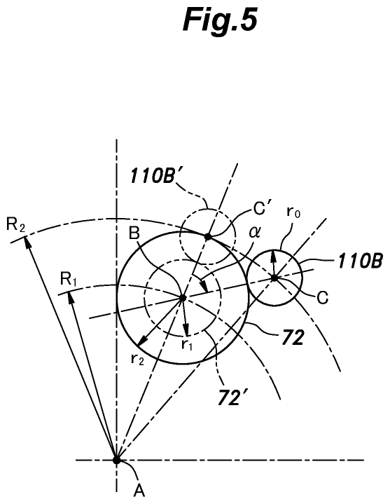

The central axial line C of the axial section 110B of the stem portion 110 and the central axial line B of the nozzle body 72 extend in parallel with each other, and are offset from each other in the circumferential direction centered around the central axial line A of the gas turbine 10 as projected on a plane extending orthogonally to the central axial line A of the gas turbine 10 as shown in FIG. 5.

More specifically, in the plane orthogonal to the central axial line A of the gas turbine 10, the central axial line C of the axial section 110B of the stem portion 110 is circumferentially offset from the line connecting the central axial line A of the gas turbine 10 with the central axial line B of the nozzle body 72 with respect to the central axial line of the nozzle body 72 by an angle α as shown in FIG. 5.

Suppose that the central axial line C of the axial section 110B of the stem portion 110 is required to be on a circle having a radius of R2 centered around the central axial line A of the gas turbine 10, and the central axial line B of the nozzle body 72 is required to be on a circle having a radius of R1 centered around the central axial line A of the gas turbine 10 as shown in FIG. 5. If central axial line C′ of the axial section 110B′ of the stem portion 110 and the central axial line B of the nozzle body 72 are positioned on a same radial line emanating from the central axial line A of the gas turbine 10, the maximum radius of the nozzle body 72 is given by r1=R2−R1−2r0, where r0 is the radius of the axial section 110B′ of the stem portion 110.

If the axial section 110B of the stem portion 110 is circumferentially offset from the line connecting the central axial line A of the gas turbine 10 with the central axial line B of the nozzle body 72 by the angle α, the maximum radius of the nozzle body 72 (r2) is greater than r1 (r2>r1). Therefore, when the axial section 110B of the stem portion 110 is circumferentially offset from the central axial line B of the nozzle body 72, the radius or the diameter of the nozzle body 72 can be increased. The increased radius may be advantageously utilized, for instance, for accommodating a swirler having a larger diameter so that an improved performance may be attained.

Further, since the central axial line D of the second inclined section 110C of the stem portion 110 and the central axial line A of the nozzle body 72 are in a skewed relationship with each other, interference between the second inclined section 110C and the nozzle body 72 can be avoided so that the overall size of the fuel injection device 70 can be minimized.

This increases freedom in the design of the layout of the fuel injection device 70 between the inner casing 14 and the combustor 54 so that the overall diameter of the gas turbine 10 can be reduced without any ill effect.

The present invention has been described in terms of a specific embodiment, but is not limited by such an embodiment, and can be modified in various ways without departing from the scope of the present invention. For instance, the axial section 110B of the stem portion 110 is not essential for the present invention, and can be omitted without departing from the scope of the present invention. In such a case, the second inclined section 110C is extended to be directly connected to the first inclined section 110A. The central axial line B of the nozzle body 72 was in parallel with the central axial line A of the gas turbine 10 in the foregoing embodiment, but the central axial line B of the nozzle body 72 may be at an angle to the central axial line A of the gas turbine 10.

1. A fuel injection device for a gas turbine, configured to inject fuel into a combustion chamber defined by a combustor, comprising:
a cylindrical nozzle body extending in a predetermined axial direction and having a first end facing the combustion chamber, the nozzle body being provided with a nozzle fuel passage extending in the axial direction, and a fuel injection port formed in an end of the nozzle fuel passage on a side of the first end; and
a stem portion connected to a side part of the nozzle body, and supporting the nozzle body on a casing of the gas turbine surrounding the combustor, the stem portion being provided with a stem fuel passage communicating with the nozzle fuel passage,
wherein the stem portion includes a first inclined section extending from a peripheral part of the nozzle body in a radial direction with respect to a central axial line of the nozzle body in a circumferentially offset relationship to a line extending between a central axial line of the gas turbine and the central axial line of the nozzle body with respect to the central axial line of the gas turbine, and a second inclined section extending from a free end of the first inclined section to the casing.

2. The fuel injection device for a gas turbine according to claim 1, wherein the stem portion further includes an axial section extending in parallel with the central axial line of the nozzle body between a radially outer end of the first inclined section and a radially inner end of the second inclined section.

3. The fuel injection device for a gas turbine according to claim 2, wherein the central axial line of the second inclined section of the stem portion and the central axial line of the nozzle body are in a skewed relationship to each other.
